(19) United States
(12) Patent Application Publication
(10) Pub. No.: US 2025/0253091 A1
(43) Pub. Date: Aug. 7, 2025

(54) REACTOR COMPONENT

(71) Applicant: DENSO CORPORATION, Kariya-City (JP)

(72) Inventors: Yoshihide FUKUDA, Kariya-City (JP); Daisuke KUDO, Kariya-City (JP); Yushi KURAHASHI, Kariya-City (JP); Masato ICHIKAWA, Kariya-City (JP)

(73) Assignee: DENSO CORPORATION, Kariya-City (JP)

(21) Appl. No.: 19/185,540

(22) Filed: Apr. 22, 2025

Related U.S. Application Data
(63) Continuation of application No. PCT/JP2023/033641, filed on Sep. 15, 2023.

(30) Foreign Application Priority Data
Nov. 15, 2022 (JP) 2022-182747

(51) Int. Cl. H01F 27/30; H01F 27/32

(52) U.S. Cl. CPC H01F 27/306; H01F 27/325

(57) ABSTRACT

A reactor component includes a coil, a core, a bobbin and a resin portion. The bobbin includes: a tubular portion, which is placed in a hollow space of the coil; two flanges, which are placed at two opposite ends, respectively, of the coil; and a pair of coupling portions, each of which extends from one of the two flanges to another one of the two flanges. The pair of coupling portions clamp a portion of the coil. Each of the coupling portions has an opposing surface in contact with an outer wall of the coil; and a resin-side wall surface that is opposite to the opposing surface and is in contact with the resin portion.

### CROSS REFERENCE TO RELATED APPLICATIONS

This application is a continuation application of International Patent Application No. PCT/JP2023/033641 filed on Sep. 15, 2023, which designated the U.S. and claims the benefit of priority from Japanese Patent Application No. 2022-182747 filed in Japan on Nov. 15, 2022. The entire disclosures of all of the above applications are incorporated herein by reference.

### TECHNICAL FIELD

The present disclosure relates to a reactor component and a method for manufacturing the same.

### BACKGROUND

According to a previously proposed technology, a reactor component includes: a lower frame body, which is disposed on a surface of a coil; and a molded resin, which covers the coil except for the inside of the lower frame body. The lower frame body has a pair of longitudinal side portions which extend along a tube axis of the coil. The pair of longitudinal side portions extend with a bottom surface of the coil interposed therebetween and are in close contact with two lower curved surfaces, respectively, adjacent to the bottom surface of the coil. The bottom surface of the coil is exposed from the molded resin over an entire lateral width range from one to the other of the lower curved surfaces with which the pair of longitudinal side portions are in close contact.

### SUMMARY

According to one aspect of the present disclosure, there is provided a reactor component that includes a coil, a core, a bobbin and a resin portion. The core is placed in a hollow space of the coil. The bobbin includes a tubular portion, two flanges and a pair of coupling portions. The tubular portion is placed in the hollow space. Each of the two flanges is formed continuously with the tubular portion. The two flanges are placed at two opposite ends, respectively, of the coil. Each of the pair of coupling portions extends from one of the two flanges to another one of the two flanges. The resin portion integrally covers the coil, the bobbin and the core.

According to another aspect of the present disclosure, there is also provided a method for manufacturing the reactor component.

### BRIEF DESCRIPTION OF DRAWINGS

The drawings described herein are for illustrative purposes only of selected embodiments and not all possible implementations, and are not intended to limit the scope of the present disclosure.

FIG. 1 is a perspective view showing a schematic configuration of a reactor component according to an embodiment.

FIG. 2 is a plan view taken in a direction of an arrow II in FIG. 1.

FIG. 3 is a cross-sectional view taken along line III-III in FIG. 1.

FIG. 4 is an exploded perspective view showing a schematic configuration of the reactor component.

FIG. 5 is a cross-sectional view showing a schematic configuration of an assembled structure before resin molding.

FIG. 6 is a cross-sectional view showing a schematic configuration of the assembled structure at the time of resin molding.

FIG. 7 is a cross-sectional view showing a schematic configuration of the assembled structure at the time of resin molding.

FIG. 8 is a cross-sectional view showing a change in a shape of a coupling portion caused by the resin molding.

FIG. 9 is a side view taken in a direction of an arrow IX in FIG. 5.

FIG. 10 is a bottom view showing a schematic configuration of an assembled structure before resin molding in a modification of the embodiment.

### DETAILED DESCRIPTION

According to a previously proposed technology, a reactor component includes: a lower frame body, which is disposed on a surface of a coil; and a molded resin, which covers the coil except for the inside of the lower frame body. The lower frame body has a pair of longitudinal side portions which extend along a tube axis of the coil. The pair of longitudinal side portions extend with a bottom surface of the coil interposed therebetween and are in close contact with two lower curved surfaces, respectively, adjacent to the bottom surface of the coil. The bottom surface of the coil is exposed from the molded resin over an entire lateral width range from one to the other of the lower curved surfaces with which the pair of longitudinal side portions are in close contact.

By the way, the reactor component may be configured to position the coil and a core using a bobbin. In this configuration, the technology described above requires the lower frame body in addition to the bobbin to suppress formation of the molded resin on a portion of the coil. Therefore, the configuration described above has a disadvantage of an increased number of constituent components. From the above perspective, or from other perspectives not mentioned, further improvements are required for the reactor component.

According to one aspect of the present disclosure, there is provided a reactor component including:
a coil that is wound and is shaped in a tubular form, wherein the coil has an opening at each of two opposite ends of the coil;
a core that is placed in a hollow space of the coil;
a bobbin that is a positioning member and is configured to position the coil and the core, wherein the bobbin includes:
   a tubular portion, which is placed in the hollow space;
   two flanges, each of which is formed continuously with the tubular portion, wherein the two flanges are placed at the two opposite ends, respectively, of the coil; and
   a pair of coupling portions, each of which extends from one of the two flanges to another one of the two flanges; and
a resin portion that integrally covers the coil, the bobbin and the core, wherein:
the pair of coupling portions clamp a portion of the coil, wherein each of the pair of coupling portions has:
   a coil-side wall surface that has a section in contact with an outer wall of the coil in at least a part of the outer wall between one opening end and another opening end of the coil; and
   a resin-side wall surface that is an opposite surface opposite to the coil-side wall surface and is in contact with the resin portion, wherein each of the pair of coupling portions partitions the resin portion from the portion of the coil, which is clamped between the pair of coupling portions, so that the portion of the coil is exposed from the resin portion.

As described above, the reactor component includes the bobbin having the pair of coupling portions. Each of the pair of coupling portions includes the coil-side wall surface and the resin-side wall surface and partitions the resin portion from the portion of the coil, which is clamped between the pair of coupling portions, so that the portion of the coil is exposed from the resin portion. Thus, the reactor component can suppress the formation of the resin portion on the portion of the coil by using the bobbin. Therefore, the reactor component can suppress the formation of the resin portion on the portion of the coil while limiting an increase in the number of constituent components of the reactor component.

According to another aspect of the present disclosure, there is provided a method for manufacturing a reactor component that includes:
a coil that is wound and is shaped in a tubular form, wherein the coil has an opening at each of two opposite ends of the coil;
a core that is placed in a hollow space of the coil;
a bobbin that is a positioning member and is configured to position the coil and the core, wherein the bobbin includes:
   a tubular portion, which is placed in the hollow space;
two flanges, which are connected to the tubular portion and are placed at the two opposite ends, respectively, of the coil; and
   a pair of coupling portions, each of which extends from one of the two flanges to another one of the two flanges; and
a resin portion that integrally covers the coil, the bobbin and the core, the method including:
an assembling step, in which the bobbin and the coil are assembled together such that the portion of the coil is clamped by the pair of coupling portions, and a distal end surface of each of the pair of coupling portions is brought into contact with the outer wall of the coil in at least the part of the outer wall between the one opening end and the another opening end of the coil;
a placing step, in which an assembled structure having the coil, the core and the bobbin assembled together is placed in a molding die such that the portion of the coil, which is clamped by the pair of coupling portions, is placed in a state where the portion of the coil is isolated from a surrounding area around the coil by the molding die and the pair of coupling portions; and
a molding step, in which the resin portion is molded after the placing step such that the portion of the coil, which is clamped by the pair of coupling portions, is exposed from the resin portion, wherein:
in the molding step, while the pair of coupling portions are flexed by a molding pressure across the coil from the one opening end to the another opening end of the coil to urge the coil-side wall surface, which includes the distal end surface, of each of the pair of coupling portions against the outer wall, the resin portion is molded on the opposite surface of each of the pair of coupling portions, which is opposite to the coil-side wall surface.

As described above, in the method for manufacturing the reactor component, during the molding step performed after the placing step, the resin portion is formed on the opposite surface of each coupling portion opposite to the coil-side wall surface while the coupling portion is flexed by the molding pressure to urge the coil-side wall surface, including the distal end surface, against the outer wall of the coil. Therefore, it is possible to manufacture the reactor component that can suppress the formation of the resin portion on the portion of the coil while limiting an increase in the number of constituent components of the reactor component.

Hereinafter, an embodiment of the present disclosure will be described with reference to the drawings.

### (Structure)

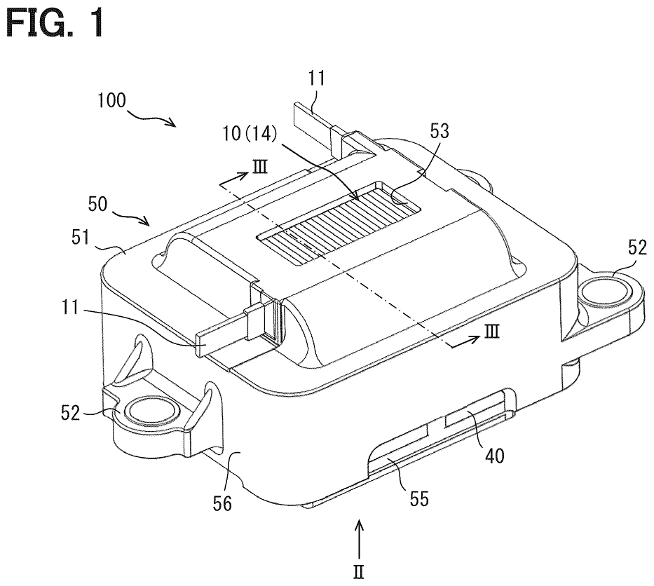

As shown in FIGS. 1, 2, 3, and 4, the reactor component 100 includes a coil 10, a bobbin (a first member 20 and a second member 30), a core 40, and a resin portion 50. The reactor component 100 is used, for example, in a voltage converter that boosts a voltage of a battery in a drive system of an electric vehicle. In other words, the reactor component 100 is a circuit device that forms a reactor in the voltage converter or the like. The reactor component 100 may also be referred to as a coil unit or a coil device.

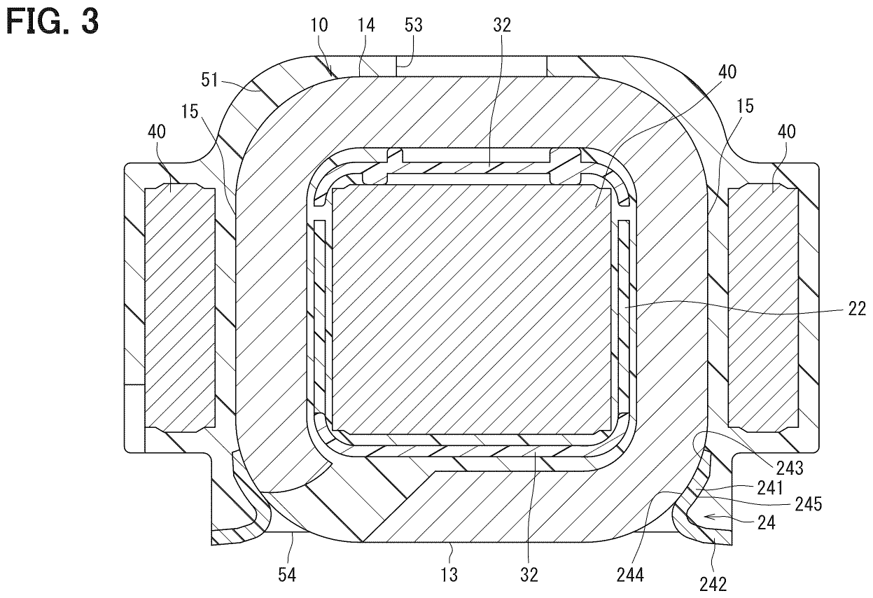

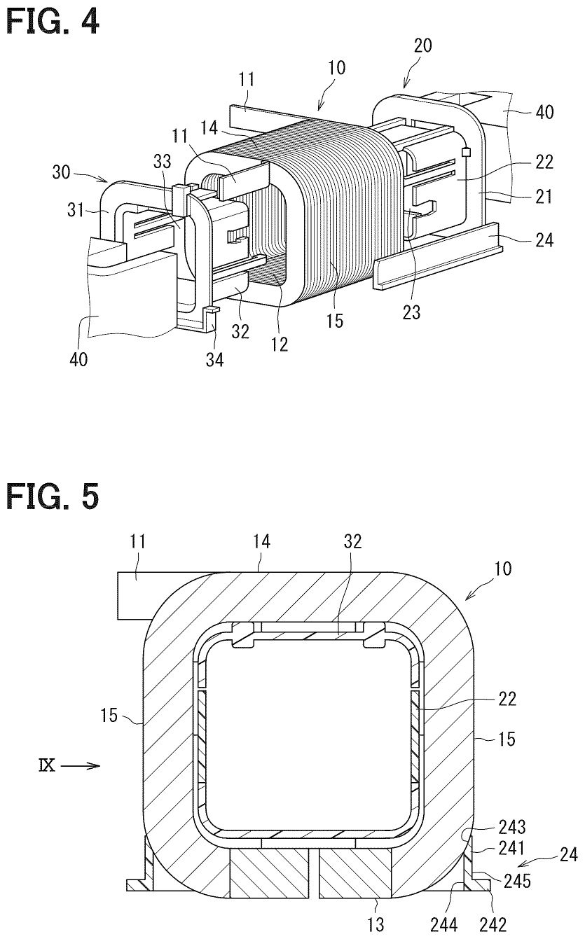

The coil 10 is in a wound state where a wire, such as an insulated wire, is wound. In the present embodiment, as shown in FIGS. 3 and 4, a rectangular wire, which has a relatively low internal resistance, is used as the wire. However, the present disclosure is not limited to this, and the wire may be a round wire. As shown in FIG. 4, the coil 10 is formed by winding the wire in a tubular form such that the coil 10 has an opening at each of two opposite ends of the coil 10. Therefore, it can be said that the coil 10 has a hole 12 surrounded by the wire. A part of the bobbin and a part of the core 40 are placed in the hole 12. The coil 10 has two lead-out portions 11, which serve as terminals of the reactor component 100 and are formed at two ends of the coil 10.

The hole 12 serves as a hollow space of the coil 10. A virtual straight line, which extends through a center of the coil 10 (hole 12), is also referred to as an axis. The axis is the virtual straight line extending from one of the openings of the coil 10 to the other one of the openings.

The coil 10 forms a wall (outer wall) as the wire is wound around the axis in a manner that extends the wall in an axial direction of the axis. The wall of the coil 10 includes: a bottom wall 13; an upper wall 14, which is opposite to the bottom wall 13; and two side walls 15, each of which is joined to the bottom wall 13 and the upper wall 14. Furthermore, the coil 10 has a bent shape (R-shape, i.e., a rounded shape) between the bottom wall 13 and each of the two side walls 15, as well as between the upper wall 14 and each of the two side walls 15. This portion with the bent shape can also be referred to as a bent portion.

The bottom wall 13 is a part of the wall of the coil 10 that is exposed from the resin portion 50. Therefore, the bottom wall 13 may also be referred to as an exposed wall. In this case, since the upper wall 14 is an opposite part of the wall of the coil 10, which is opposite to the bottom wall 13, the upper wall 14 may also be referred to as an opposite wall.

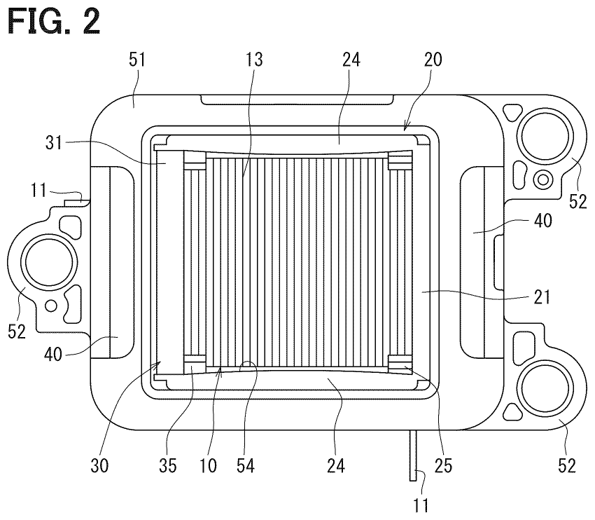

As shown in FIGS. 2 and 4, the bobbin is an integrated component in which a first member 20 and a second member 30, provided as separate components, are assembled together. The first member 20 and the second member 30 are, for example, mainly made of resin. The bobbin is a positioning member and is configured to position the coil 10 and the core 40. The bobbin can also be referred to as a member on which the coil 10 is wound.

The first member 20 includes a flange 21, a tube portion 22, a hole 23, two coupling portions 24 and two base portions 25. In the first member 20, the tube portion 22 and the coupling portions 24 project from the flange 21 in the axial direction. The hole 23, in which the core 40 is placed, extends through the flange 21 and the tube portion 22. An outer shape of the flange 21 is substantially a rectangular shape. In the present embodiment, as an example, the flange 21 with the rectangular shape having rounded corners is adopted.

The tube portion 22 is joined to the flange 21. The tube portion 22 has a fixing mechanism that fixes the tube portion 22 relative to a tube portion 32 of the second member 30. The tube portion 22 serves as a tubular portion.

The coupling portions 24 are portions to be coupled to two secondary coupling portions, respectively, 34 of the second member 30. The coupling portions 24 are provided as a pair of coupling portions 24. Therefore, in the present embodiment, the two coupling portions 24 are provided. The coupling portions 24 may be integrally molded with the flange 21 and/or the tube portion 22 or may be connected to the flange 21 and/or the tube portion 22 using a connecting member or the like.

The two coupling portions 24 are respectively formed at two corners of the flange 21 arranged side by side. Furthermore, the two coupling portions 24 are provided at positions where the coupling portions 24 clamp the bent portions of the coil 10 in a state where the coupling portions 24 are assembled to the coil 10. That is, it can also be said that the two coupling portions 24 are respectively provided at two opposite end parts of the bottom wall 13. Furthermore, it can also be said that the two coupling portions 24 are respectively provided at positions where the coupling portions 24 clamp the bottom wall 13. Here, the bent portions of the coil 10 refer to portions of the coil 10 which are joined to the bottom wall 13.

Each of the pair of coupling portions 24 partitions the resin portion 50 from a portion of the coil 10, which is clamped between the pair of coupling portions 24, so that the portion of the coil 10 is exposed from the resin portion 50. That is, each of the coupling portions 24 is a member that limits the resin portion 50 from being formed at the portion of the coil 10. Therefore, each of the coupling portions 24 may also be referred to as a resin cut portion.

The coupling portions 24 are coupled to the secondary coupling portions 34 in a state where the first member 20 and the second member 30 are assembled together. The coupling portions 24 and the secondary coupling portions 34 are coupled together, for example, by welding or fitting. The secondary coupling portions 34 are formed at a flange 31 of the second member 30. For this reason, it can be said that each of the two coupling portions 24 extends from one of the two flanges 21 to another one of the two flanges 21.

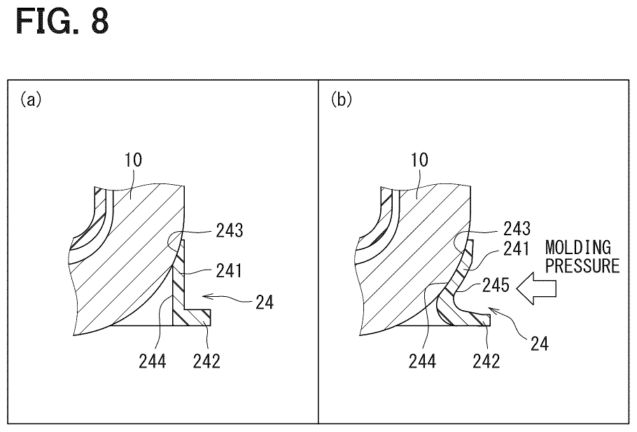

A shape of each of the coupling portions 24 changes between a state before and a state after the molding of the resin portion 50. That is, each of the coupling portions 24 is deformed by a molding pressure applied at the time of molding the resin portion 50. FIG. 5 and (a) of FIG. 8 show the coupling portion 24 in the state before the molding of the resin portion 50. FIGS. 3, 7 and (b) of FIG. 8 show the coupling portion 24 in the state after the molding of the resin portion 50. Hereinafter, the state before the molding of the resin portion 50 is also referred to as a pre-molding state, and the state after the molding of the resin portion 50 is also referred to as a post-molding state. In FIG. 7 and (b) of FIG. 8, the core 40 and the resin portion 50 are omitted.

As shown in FIG. 5 and (a) of FIG. 8, each of the coupling portions 24 includes an opposing portion 241, a projecting portion 242, a distal end surface 243, an opposing surface 244 and a resin contact surface 245. The opposing portion 241 is a portion that is opposed to the coil 10. The opposing portion 241 is placed at a position that is opposed to the bent portion between the bottom wall 13 and the side wall 15. The projecting portion 242 is a portion that projects from one end of the opposing portion 241. The projecting portion 242 projects away from the coil 10 relative to the opposing portion 241. Therefore, in the pre-molding state, it can be said that a cross-section of each coupling portion 24, which is perpendicular to the axis, has an L-shape.

Furthermore, as shown in FIG. 3, FIG. 7, and (b) of FIG. 8, each coupling portion 24 is urged and is deformed by the molding pressure toward the coil 10. That is, in the post-molding state, each of the coupling portions 24 can be said to have: the opposing portion 241 that is bent along a curved surface of the outer wall such that a distance between the opposing portions 241 of the of coupling portions 24 decreases; and the projecting portion 242 that is formed continuously with the opposing portion 241 such that a distance between the projecting portions 242 of the coupling portions 24 increases. Furthermore, as shown in FIG. 2, the coupling portions 24 are shaped such that a distance between the coupling portions 24 gradually decreases and then gradually increases as the coupling portions 24 extend from the one flange 21 toward the other flange 31. In (b) of FIG. 8, the molding pressure is indicated by a blank arrow.

Furthermore, as shown in FIG. 5, each of the coupling portions 24 is shaped such that a length of the opposing portion 241 is longer than a length of the projecting portion 242. That is, a height of the opposing portion 241 is larger than the length of the projecting portion 242. The height of the opposing portion 241 is a length measured in a direction along a perpendicular line that is perpendicular to the bottom wall 13 and/or the upper wall 14. The length of the projecting portion 242 is a length measured in a projecting direction of the projecting portion 242 relative to the opposing portion 241. This configuration allows the coupling portion 24 to more uniformly receive the molding pressure. Furthermore, the coupling portion 24 is likely to deform in such a way that the opposing portion 241 is easily deformed by the molding pressure toward the coil 10.

The distal end surface 243 is a surface which is located at a distal end portion of the opposing portion 241 and is opposed to the coil 10. The distal end surface 243 is in contact with the bent portion between the bottom wall 13 and the side wall 15 in both the pre-molding state and the post-molding state. The distal end surface 243 is in contact with the bent portion across the coil 10 from the one opening end to the other one opening end of the coil 10. It is preferable that the distal end surface 243 has a shape that conforms to the shape of the bent portion to improve the degree of close contact of the distal end surface 243 relative to the bent portion.

The opposing surface 244 is a surface which is continuous with the distal end surface 243 and is opposed to the coil 10. The opposing surface 244 is separated from the bent portion in the pre-molding state. However, in the post-molding state, at least a part of the opposing surface 244 is in contact with the bent portion across the coil 10 from the one opening end to the other opening end of the coil 10. This is because the opposing portion 241 is deformed by the molding pressure. That is, the coupling portion 24 is flexed by the molding pressure at the time of molding the resin portion 50, causing the part of the opposing surface 244 and the distal end surface 243 to come into contact with the bent portion.

It can be said that, in the post-molding state, each of the distal end surface 243 and the opposing surface 244 has the section that is brought into contact with the outer wall (bent portion) of the coil 10 across the coil 10 from the one opening end to the other opening end of the coil 10. The distal end surface 243 and the opposing surface 244 serve as a coil-side wall surface. The distal end surface 243 and the opposing surface 244 may be in contact with the bent portion in at least a part of the bent portion between the one opening end and the other opening end of the coil 10.

The coupling portion 24 is preferably configured such that the opposing portion 241 is more easily deformable to improve the degree of close contact of the distal end surface 243 and the opposing surface 244 relative to the coil 10. For this reason, the coupling portion 24 may be configured such that a wall thickness of the opposing portion 241 is smaller than a wall thickness of the projecting portion 242.

The resin contact surface 245 is an opposite surface opposite to the distal end surface 243 and the opposing surface 244. The resin contact surface 245 is a surface that comes into contact with the resin portion 50 in the post-molding state. The resin contact surface 245 has two planar surfaces which are perpendicular to each other in the pre-molding state. However, in the post-molding state, since the coupling portion 24 is deformed, the resin contact surface 245 becomes a curved surface. The resin contact surface 245 serves as a resin-side wall surface.

The coupling portions 24 are also referred to as primary coupling portions in view of the secondary coupling portions 34. Furthermore, the coupling portion 24 may also be referred to as an arm portion. In the present embodiment, the example, in which the coupling portions 24 are provided on the first member 20, is adopted. However, the present disclosure is not limited to this. It is only required that the coupling portions 24 are provided on the bobbin.

As shown in FIG. 2, each base portion 25 is formed at a base of the corresponding coupling portion 24, which is placed adjacent to the flange 21. The base portion 25 limits the resin portion 50 from being formed at the base of the corresponding coupling portion 24. Each base portion 25 serves as a rib.

The second member 30 includes the flange 31, the tube portion 32, a hole 33, the two secondary coupling portions 34 and two base portions 35. In the second member 30, the tube portion 32 projects from the flange 31 in the axial direction. The hole 33, in which the core 40 is placed, extends through the flange 31 and the tube portion 32. An outer shape of the flange 31 is substantially the same as that of the flange 21.

The tube portion 32 is joined to the flange 31. The tube portion 32 has a fixing mechanism that fixes the tube portion 32 relative to the tube portion 22 of the first member 20. The tube portion 32 serves as the tubular portion in cooperation with the tube portion 22.

The secondary coupling portions 34 are respectively formed at two corners of the flange 31 arranged side by side. The secondary coupling portions 34 are portions to be coupled with the coupling portions 24 of the first member 20. As shown in FIG. 2, each base portion 35 is formed at a base of the corresponding secondary coupling portion 34, which is placed adjacent to the flange 31. The base portion 35 limits the resin portion 50 from being formed at the base of the corresponding secondary coupling portion 34. Each base portion 35 serves as a rib.

The first member 20 and the second member 30 are integrated in a state where the tube portions 22, 32 are placed in the hole 12. Furthermore, the first member 20 and the second member 30 are integrated by being fixed through the fixing mechanisms of the tube portions 22, 32. The fixing mechanism may be of a type that utilizes resilient force for fitting together, such as a snap-fit. However, the tube portion 22 and the tube portion 32 may be coupled with each other by another type of fixing mechanism.

Furthermore, the first member 20 and the second member 30 are positioned relative to the coil 10 as the tube portions 22, 32 are arranged in the hole 12. The first member 20 and the second member 30 are positioned relative to the core 40 as the core 40 is arranged in the holes 23, 33. Therefore, the bobbin positions the coil 10 and the core 40 as the tube portions 22, 32 are arranged in the hole 12 of the coil 10, and the core 40 is arranged in the holes 23, 33.

The flanges 21, 31 are arranged to clamp the coil 10 in a state where the first member 20 and the second member 30 are integrated together. That is, the flanges 21, 31 are respectively arranged at the two opposite ends of the coil 10 in the axial direction.

The present embodiment adopts the bobbin 20, 30, which includes the first member 20 and second member 30 that are separately formed. However, the present disclosure can also adopt a bobbin in which the first member 20 and the second member 30 are integrally formed in one-piece.

The core 40 is placed in the hole 12. The core 40 is made of a magnetic material and forms a magnetic circuit in cooperation with the coil 10. A magnetic flux, which is generated by an electric current conducted through coil 10, passes through the core 40. For example, the core 40 is divided into a pair of U-shaped core parts, which are arranged to face each other to form a ring-shaped core.

As shown in FIGS. 1, 2 and 3, the resin portion 50 includes a base body 51 and mounting portions 52. The resin portion 50 integrally covers the coil 10, the first member 20, the second member 30 and the core 40. The base body 51 covers the coil 10. Specifically, the base body 51 does not entirely cover the coil 10 and the core 40 but covers the coil 10 and the core 40 in a manner that leaves parts thereof exposed.

The coil 10 generates heat when the electric current flows through the coil 10. The heat, which is generated by the coil 10, is transmitted to the core 40. Therefore, the base body 51 is provided in a manner that leaves the parts of the coil 10 and the core 40 exposed to facilitate heat dissipation from the coil 10.

For this purpose, the base body 51 has a first window 53 and a second window 55. The first window 53 is a hole formed in the base body 51. The first window 53 is formed in an opposing region of the base body 51 that is opposed to a part of the upper wall 14. As a result, the part of the upper wall 14 of the coil 10 is exposed from the base body 51.

The second window 55 is a hole formed in the base body 51. The second window 55 is formed in an opposing region of the base body 51 that is opposed to a part of the side wall 15. Specifically, the second window 55 is formed such that a part of the core 40, which is opposed to the side wall 15, is exposed from the base body 51. However, the present disclosure can also be applied to a configuration in which the first window 53 and the second window 55 are not provided.

Furthermore, as shown in FIG. 2, the base body 51 of the resin portion 50 is formed such that at least a part of the bottom wall 13 is exposed from the base body 51. The base body 51 has an opening in a region surrounded by the flanges 21, 31 and the coupling portions 24. That is, the base body 51 is provided around a region, which is surrounded by the flanges 21, 31 and the coupling portions 24. As a result, the reactor component 100 can enhance the heat dissipation from the bottom wall 13 compared to a structure in which the opposing region of base body 51, which is opposed to the bottom wall 13, is not opened. An empty space 54 is a space between the coupling portions 24 and the coil 10. The empty space 54 is in communication with the opening of the base body 51.

As shown in FIG. 2, the present embodiment adopts the example, in which a part of the core 40, along with the bottom wall 13, is also exposed from the base body 51. However, the present disclosure is not limited to this.

The mounting portions 52 project outward from the base body 51. The mounting portions 52 serve to attach the reactor component 100 to a mounting target. Each of the mounting portions 52 is provided with a through-hole into which a fastening member such as a bolt is inserted. The reactor component 100 is attached to the mounting target such that the bottom wall 13 is opposed to the mounting target. The reactor component 100 is secured to the mounting target by fastening the mounting portions 52 with the bolts.

It is preferable that the reactor component 100 is attached to the mounting target through a heat dissipation member, such as a heat dissipation sheet or heat dissipation grease. As described above, in the reactor component 100, the bottom wall 13 is exposed from the resin portion 50. Therefore, the reactor component 100 can bring the bottom wall 13 into contact with the heat dissipation member. Accordingly, the reactor component 100 can improve the heat dissipation compared to a structure in which the bottom wall 13 is not in contact with the heat dissipation member.

### (Manufacturing Method)

A method (manufacturing method) for manufacturing the reactor component 100 will be described with reference to FIGS. 4 to 9. As shown in FIG. 4, the reactor component 100 is divided into the coil 10, the first member 20, the second member 30 and the core 40.

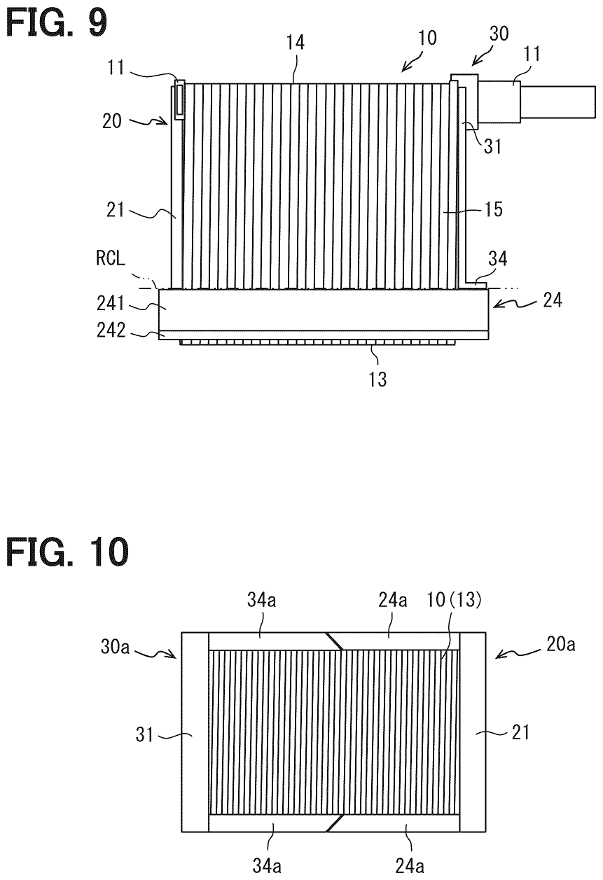

First, an assembling step is performed to assemble the bobbin and the coil 10. In the assembling step, the first member 20 and the second member 30 are installed such that the tube portions 22, 32 are positioned in the hole 12 of the coil 10, and the flanges 21, 31 clamp the coil 10 therebetween. In the assembling step, as shown in FIGS. 5 and 9, the assembling is carried out such that the portion of the coil 10 is clamped between the coupling portions 24, and the distal end surface 243 of each of the coupling portions 24 is brought into contact with the outer wall of the coil 10 across the coil 10 from the one opening end to the other opening end of the coil 10. Therefore, the bobbin and the coil 10 are assembled. In FIG. 9, the reference sign RCL indicates a resin cut line. The resin cut line is a boundary between a region where the resin portion 50 is formed and a region where the resin portion 50 is not formed with respect to the coil 10.

In the assembling step, the core 40 may be assembled to the bobbin and the coil 10. In this case, the core 40 is assembled such that a part of the core 40 is positioned in the holes 23, 33. An assembly of the bobbin, the coil 10 and the core 40 serves as an assembled structure.

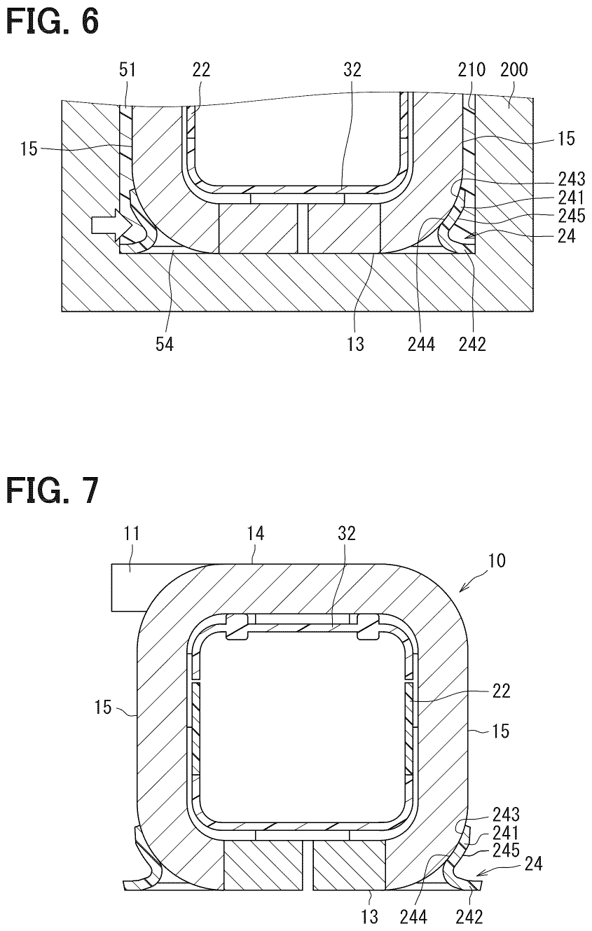

Next, a placing step in which the assembled structure is placed in a molding die 200, and a molding step in which the resin portion 50 is molded after the placing step, are performed. As shown in FIG. 6, in the placing step, the portion of the coil 10 clamped by the coupling portions 24 is placed in a state where the portion of the coil 10 is isolated from a surrounding area around the coil by the molding die 200 and the coupling portions 24. That is, in the placing step, the bottom wall 13 is arranged to oppose the molding die 200, and the projecting portions 242 are arranged to be in contact with the molding die 200. In the present embodiment, not only the coupling portions 24 but also the flanges 21, 31 are arranged to be in contact with the molding die 200. Therefore, in the placing step, the coupling portions 24, the flanges 21, 31 and the molding die 200 are set to limit the formation of the resin portion 50 in spaces enclosed by the coupling portions 24, the flanges 21, 31 and the molding die 200.

Then, as shown in FIG. 6, in the molding step, the resin portion 50 is formed such that the portion of the coil 10, which is clamped by the coupling portions 24, is exposed from the resin portion 50. In the molding step, for example, the resin portion 50 is formed by injection molding.

As indicated by a blank arrow in FIG. 6, in the molding step, the molding pressure is applied to each of the coupling portions 24. In the molding step, each of the coupling portions 24 is flexed by the molding pressure across the coil 10 from the one opening end to the other opening end of the coil 10. At this time, each of the coupling portions 24 is deformed while the projecting portion 242 remains in contact with the molding die 200. Additionally, in the molding step, the resin portion 50 is formed while pressing the coil-side wall surface, including the distal end surface 243, against the outer wall of the coil 10 by the molding pressure. Here, the outer wall refers to the bent portion between the bottom wall 13 and the side wall 15, as described above.

As described above, in the molding step, the resin portion 50 is formed while urging the coupling portions 24 against the outer wall of the coil 10. Therefore, the resin portion 50 is formed, with the resin cut line RCL as the boundary, on the upper wall 14 of the coil 10, on each bent portion between the upper wall 14 and the side wall 15, and on the area of each side wall 15 exposed from the coupling portion 24. Additionally, the resin portion 50 is not formed on the bottom wall 13 of the coil 10 and on each bent portion between the bottom wall 13 and the side wall 15.

The relationship between the molding pressure applied to the coupling portion 24 and the amount of flexure of the coupling portion 24 can be analyzed through simulations or other methods. The shape of the coupling portion 24 is designed based on the result of this analysis. That is, each coupling portion 24 is designed to have the aforementioned shape in the post-molding state.

### (Advantages)

As described above, the reactor component 100 includes the bobbin having the coupling portions 24. Each of the coupling portions 24 has: the distal end surface 243 and the opposing surface 244, which are configured to contact the coil 10; and the resin contact surface 245, which is configured to contact the resin portion 50, and each of the coupling portions 24 partitions the resin portion 50 from the portion of the coil 10, which is clamped between the coupling portions 24, so that the portion of the coil 10 is exposed from the resin portion 50. Thus, the reactor component 100 can suppress the formation of the resin portion 50 on the portion of the coil 10 by using the bobbin. Therefore, the reactor component 100 can suppress the formation of the resin portion 50 on the portion of the coil 10 while limiting an increase in the number of constituent components of the reactor component 100.

Furthermore, in the reactor component 100, the resin contact surface 245 has the curved shape in the post-molding state. Therefore, the reactor component 100 can increase the contact surface area between the resin contact surface 245 and the base body 51 in comparison to a case where the resin contact surface 245 is a planar surface.

The reactor component 100 has the projecting portions 242 each of which projects from the end of the corresponding one of the opposing portions 241. Therefore, the reactor component 100 can more effectively suppress the intrusion of a part of the resin portion 50 and/or a foreign object into the empty space 54 during the molding step compared to a configuration without the projecting portions 242. That is, in the reactor component 100, each of the projecting portions 242 deforms while the projecting portion 242 is in contact with the molding die 200. Therefore, it can be said that the projecting portions 242 has a function of suppressing the entry of the part of the resin portion 50 and/or the foreign object into the empty space 54.

Further, in the manufacturing method of the reactor component 100, during the molding step performed after the placing step, the resin portion 50 is formed on the resin contact surface 245 while the coupling portion 24 is flexed by the molding pressure to urge the coil-side wall surface, including the distal end surface 243, against the outer wall of the coil 10. Therefore, it is possible to manufacture the reactor component 100 that can suppress the formation of the resin portion 50 on the portion of the coil 10 while limiting an increase in the number of constituent components of the reactor component 100.

Further, in the manufacturing method of the reactor component 100, since the coupling portion 24 is flexed to bring the distal end surface 243 into contact with the coil 10, the tolerance of the coupling portion 24 can also be absorbed. That is, the manufacturing method of the reactor component 100 can separate the resin portion 50 at the resin cut line RCL even if there are variations in the coupling portions 24.

### Modifications

The bobbin may have a configuration as in a modification shown in FIG. 10. The bobbin of the modification includes a first member 20a, which has a pair of coupling portions 24a, and a second member 30a, which has a pair of secondary coupling portions 34a. In the assembled state of the first member 20a and the second member 30a, distal ends of the coupling portions 24a contact distal ends of the secondary coupling portions 34a. Each of the coupling portions 24a and the secondary coupling portions 34a have, for example, a surface that is tilted relative to the axis. The coupling portions 24a and the secondary coupling portions 34a serve as coupling portions. That is, in the modification, it can be said that the coupling portions are formed by the combination of the coupling portions 24a and the secondary coupling portions 34a.

Although the present disclosure has been described with reference to the embodiments, it should be understood that the present disclosure is not limited to the embodiments and the structures described therein. The present disclosure also includes various variations and variations within the equivalent range. In addition, the various combinations and forms are shown in this disclosure. However, other combinations and forms including only one element, more or less, are also within the scope and idea of the present disclosure.

What is claimed is:

1. A reactor component comprising:
a coil that is wound and is shaped in a tubular form, wherein the coil has an opening at each of two opposite ends of the coil;
a core that is placed in a hollow space of the coil;
a bobbin that is a positioning member and is configured to position the coil and the core, wherein the bobbin includes:
a tubular portion, which is placed in the hollow space;
two flanges, each of which is formed continuously with the tubular portion, wherein the two flanges are placed at the two opposite ends, respectively, of the coil; and
a pair of coupling portions, each of which extends from one of the two flanges to another one of the two flanges; and
a resin portion that integrally covers the coil, the bobbin and the core, wherein:
the pair of coupling portions clamp a portion of the coil, wherein each of the pair of coupling portions has:
a coil-side wall surface that has a section in contact with an outer wall of the coil in at least a part of the outer wall between one opening end and another opening end of the coil; and
a resin-side wall surface that is an opposite surface opposite to the coil-side wall surface and is in contact with the resin portion, wherein each of the pair of coupling portions partitions the resin portion from the portion of the coil, which is clamped between the pair of coupling portions, so that the portion of the coil is exposed from the resin portion; and
each of the pair of coupling portions has:
an opposing portion that is bent along a curved surface of the outer wall such that a distance between the opposing portions of the pair of coupling portions decreases; and
a projecting portion that is formed continuously with the opposing portion such that a distance between the projecting portions of the pair of coupling portions increases.

2. The reactor component according to claim 1, wherein a distance between the pair of coupling portions gradually decreases and then gradually increases as the pair of coupling portions extend from the one of the two flanges toward the another one of the two flanges.

3. The reactor component according to claim 1, wherein the opposing portion of each of the pair of coupling portions has a wall thickness that is smaller than a wall thickness of the projecting portion of each of the pair of coupling portions.

4. The reactor component according to claim 1, wherein a height of the opposing portion of each of the pair of coupling portions is larger than a length of the projecting portion of each of the pair of coupling portions.

5. The reactor component according to claim 1, wherein a base of each of the pair of coupling portions, which is adjacent to an adjacent one of the two flanges, has a rib.

6. The reactor component according to claim 1, wherein each of the pair of coupling portions is flexed by a molding pressure applied at a time of molding the resin portion, so that the section of the coil-side wall surface of each of the pair of coupling portions is brought into contact with the outer wall.
